(19) United States
(12) Patent Application Publication
(10) Pub. No.: US 2014/0239139 A1
(43) Pub. Date: Aug. 28, 2014

(54) VIDEO DISPLAY SYSTEM AND METHOD FOR ASSEMBLING

(71) Applicant: TAIT TECHNOLOGIES BVBA, Waardamme (BE)

(72) Inventor: Frederic Frank OPSOMER, Kortemark (BE)

(73) Assignee: TAIT TECHNOLOGIES BVBA, Waardamme (BE)

(21) Appl. No.: 13/895,792

(22) Filed: May 16, 2013

(30) Foreign Application Priority Data
Feb. 28, 2013 (BE) 2013/0129

(51) Int. Cl. F16M 13/00

(52) U.S. Cl. CPC F16M 13/00
USPC 248/329; 248/327; 29/428

(57) ABSTRACT

A video display system having a plurality of portable video support structures. Each of the portable video support structures includes at least one base support assembly and at least one lift support assembly having a lifting device configured to lift a plurality of video display subcomponents and a retention device receiving and supporting the plurality of video display subcomponents. One or both of the lifting device and the retention device is capable of movement to position the plurality of video display subcomponents and the video display subcomponents detachably engaged with one another to form a substantially continuous display surface. A method of assembling a video display system and a video support structure are also disclosed.

### FIELD OF THE INVENTION

The present invention is directed to a video support structure and a video support system. More specifically, the present invention is directed to a support structure having lifting and support members capable of positioning and servicing individual video display subcomponents.

### BACKGROUND OF THE INVENTION

In the performance industry, video display systems operate in conjunction with other multi-media systems, for example, lighting and sound, as part of a concert, performance, or stage production. Support structures for the video display systems typically include complicated and/or large individual components that require assembly of the components. Use of conventional connectors, such as threaded bolts or screws, increases the complexity of assembly and further increases the time and labor required for assembly and disassembly. When being part of a touring production, the video support structures must be sturdy to withstand the rigors of outdoor use, yet portable and capable of being broken down into relatively smaller units that can be loaded into trucks or other vehicles for transport. In addition, the portable structures must be capable of assembly and disassembly, by personnel having little or no technical skill. The above benefits must be accounted for while providing a video support structure and a video display system in conjunction with multi-media productions.

Video support structures as part of a concert, performance, or stage production are typically of custom design requiring on-site fabrication and alterations, often resulting in the added expense of additional time and labor to complete the construction. Structural components that permit the option of alterations, for example, a curved backdrop or a bridge, while maintaining ease of assembly and disassembly, would be desirable.

Video display systems also include a plurality of illumination panels or video display units, including low resolution illumination panels, high resolution illumination panels, or a combination thereof. Illumination panels are part of a video display system and interconnected so that individual illumination panels project an image as a portion of a larger video display. When a defective video display unit is observed, it detracts from the multi-media presentation, and therefore, must be replaced. Removing and replacing one or more video display units within the video support structure is a difficult task due to the complexity of the video support structure. Typically, in the current system, entire sections or the entire displays must be fully disassembled to remove or service an individual video display unit. This extensive disassembly increases the cost and time associated with servicing and maintaining display systems.

What is needed is a portable video support structure and a video display system incorporating low and/or high resolution video display units, capable of custom installation, easily assembled and disassembled with little or no technical skill, disassembled into smaller components for transportation and storage, having replaceable video display units, where the structure does not suffer from the drawbacks of the prior art.

### BRIEF DESCRIPTION OF THE INVENTION

One aspect of the disclosure refers to a portable video support structure having at least one base support assembly and at least one lift support assembly. The lift support assembly includes a lifting device configured to lift a plurality of video display subcomponents and a retention device configured to receive and support the plurality of video display subcomponents. One or both of the lifting device and the retention device are capable of movement to position the plurality of video display subcomponents.

Another aspect of the disclosure refers to a method of assembling a video display system. The method includes providing a video support structure having at least one base support assembly and at least one lift support assembly. The lift support assembly includes a lifting device and a retention device. A video display subcomponent is provided and the video display subcomponent is lifted with the lifting device. An additional video display subcomponent is provided and detachably engaged with the video display subcomponent. The video display subcomponent and the additional video display subcomponent are lifted with the lifting device. Additional video display subcomponents are provided, detachably engaged and lifted until a predetermined number of video display subcomponents are engaged with one another. One of the video display subcomponents or the additional video display subcomponents are detachably engaged to the retention member to form a substantially continuous display surface.

Still another aspect of the disclosure refers to a video display system having a plurality of portable video support structures. Each of the portable video support structures include at least one base support assembly and at least one lift support assembly having a lifting device configured to lift a plurality of video display subcomponents and a retention device receiving and supporting the plurality of video display subcomponents. One or both of the lifting device and the retention device is capable of movement to position the plurality of video display subcomponents and the video display subcomponents detachably engaged with one another to form a substantially continuous display surface.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an exemplary video display system according to the present disclosure.

FIG. 2A is an exploded view of a video support structure according to the present disclosure.

FIG. 2B is an assembled view of a video support structure according to the present disclosure.

FIG. 3 is a winch cart according to the present disclosure.

FIG. 4 is a video support structure illustrating a method according to the present disclosure.

FIG. 5 is a video support structure illustrating a method according to the present disclosure.

FIG. 6A is a video support structure illustrating a method according to the present disclosure.

FIG. 6B is an enlarged view of a portion of FIG. 6A.

FIG. 7A is a video support structure illustrating a method according to the present disclosure.

FIG. 7B is an enlarged view of a portion of FIG. 7A.

FIG. 8A is a video support structure illustrating a method according to the present disclosure.

FIG. 8B is an enlarged view of a portion of FIG. 8A.

FIG. 9 is a video support structure illustrating a method according to the present disclosure.

FIG. 10 is a video support structure illustrating a method according to the present disclosure.

FIG. 11 is a video support structure illustrating a method according to the present disclosure.

FIG. 12 is a video support structure illustrating a method according to the present disclosure.

FIG. 13A is a video support structure illustrating a method according to the present disclosure.

FIG. 13B is an enlarged view of a portion of FIG. 13A.

FIG. 14A is a video support structure illustrating a method according to the present disclosure.

FIG. 14B is an enlarged view of a portion of FIG. 14A.

FIG. 15 is an arrangement of video support structures forming a support system for a video display system having an arced geometry according to the present disclosure.

FIG. 16 is an arrangement of video support structures forming a support system for a video display system having a non-symmetrical geometry according to the present disclosure.

FIG. 17 illustrates a method for servicing a video display system with a video support structure according to the present disclosure.

FIG. 18 is an enlarged view of a portion of the video display system of FIG. 17.

FIGS. 19A and 19B are enlarged views of the lifting device and the retention device of the video display system of FIG. 17.

FIG. 20 illustrates a method for servicing a video display system with a video support structure according to the present disclosure.

FIG. 21 illustrates a method for servicing a video display system with a video support structure according to the present disclosure.

FIG. 22 illustrates a method for servicing a video display system with a video support structure according to the present disclosure.

FIG. 23 illustrates a method for servicing a video display system with a video support structure according to the present disclosure.

FIG. 24 illustrates a method for servicing a video display system with a video support structure according to the present disclosure.

FIG. 25 illustrates a method for servicing a video display system with a video support structure according to the present disclosure.

FIG. 26 illustrates a method for servicing a video display system with a video support structure according to the present disclosure.

FIG. 27 illustrates a method for servicing a video display system with a video support structure according to the present disclosure.

Wherever possible, the same reference numbers will be used throughout the drawings to represent the same parts.

### DETAILED DESCRIPTION OF THE INVENTION

Provided is an exemplary portable video support structure and a video display system. Embodiments of the present disclosure permit the construction of a portable video support structure that is easily assembled and disassembled by hand, with little assistance of tools, by personnel having little or no technical skill, and further disassembled into relatively small units for transport and storage. Embodiments of the present disclosure create an illusion of a continuous image or video over a large surface.

One embodiment includes a video display system having a plurality of high resolution and low resolution video display units, where one or more video display units are removed, serviced or replaced without disassembly of the video support structure.

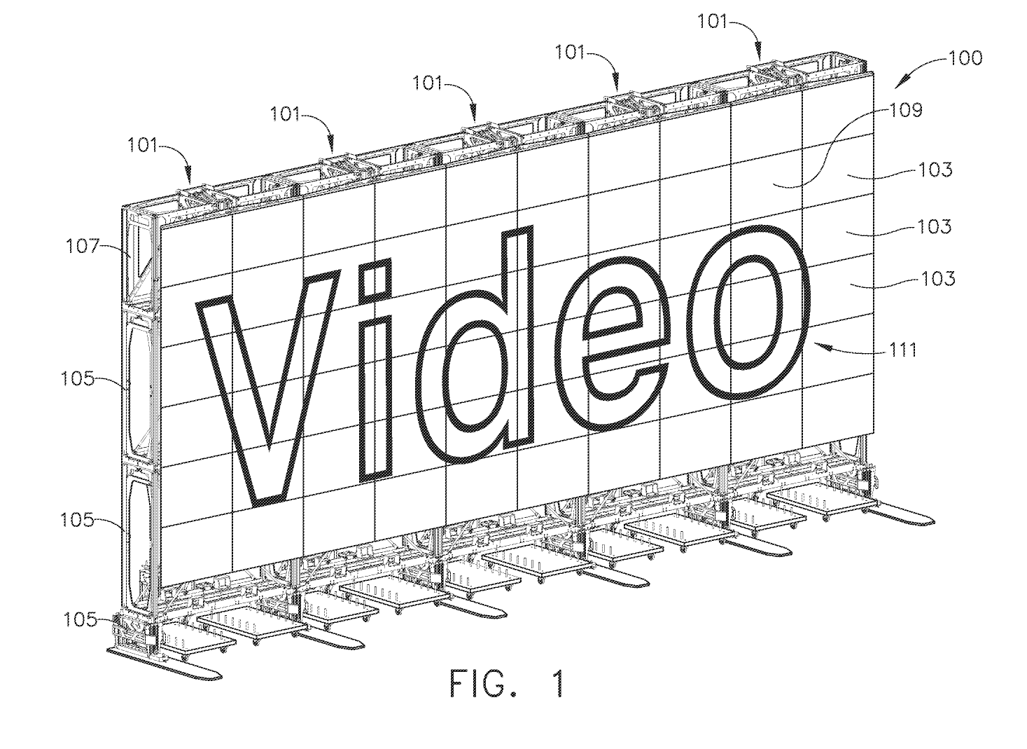

FIG. 1 shows a portable video display system 100, according to an embodiment of the disclosure. The video display system 100 is made up of a plurality of video support structures 101 supporting a plurality of video display subcomponents 103. The video support structures 101 are made up of base support assemblies 105 and a lift support assembly 107 that support and retain the plurality of video display subcomponents 103. The video display subcomponents 103 are detachably engaged to one another via any latch or other suitable fastener known in the art for detachably engaging mechanical components. Preferably, the latches do not require the assistance of tools to attach or detach the components from one another. Suitable latches may include draw latches. Portable video display system 100 of the present disclosure is portable, allowing easy assembly and disassembly, preferably with little or no assistance from tools.

In one embodiment, video display subcomponents 103 are made up of or contain one or more light emitting devices. Suitable light emitting devices include light emitting diodes (LEDs), for example, or any suitable light emitting elements such as video strips, organic light emitting diodes (OLEDs), fiber-optic lights, fluorescent lights, incandescent lights, neon lights, polymer light emitting diodes, electroluminescent lights, or combinations thereof. For example, the light emitting devices may be a system of light emitting diodes (LEDs) housed within a housing that may be transparent, translucent, semi-transparent, semi-translucent, or a combination thereof. In one embodiment, the LEDs may be configured to emit colored light based upon a signal from a controller. In another embodiment, the light emitting devices may emit multiple colors of light simultaneously or at different times. In yet another embodiment, multiple LEDs may be housed within the same housing. LEDs are configured to emit multiple colors such that the different colors are mixed within the housing thereby permitting additional control of the image or series of images displayed.

In another embodiment, the video display subcomponents 103 may be connected to each other in a grid pattern of wires. Wires may be connected to the light emitting devices by any suitable technique or connector. Wires can provide support for adjacent light emitting devices within the display device. In another embodiment, the light emitting devices may be connected with wires that are fiber-optic cables permitting the light to be emitted from various sources. In yet another embodiment, wires may be translucent, transparent, semi-transparent, semi-translucent, semi-opaque, opaque, or combinations thereof. In another embodiment, the video display subcomponents 103 may utilize wireless control and/or wireless power to provide control and power from a remote location.

In yet another embodiment, the video display subcomponent 103 is a low resolution or a high resolution video panel configured to display lighting and/or video presentations. For example, a large number of closely spaced LEDs may be included thereby creating the effect that LEDs are of high resolution. In another embodiment, the panels additionally or alternatively include OLEDs or other light sources capable of displaying images, video, or other visual displays. The video display subcomponents 103 may be transparent, translucent, semi-transparent, semi-translucent, opaque, semi-opaque, or combinations thereof. In addition, LEDs may be connected by electrical and/or control wires of other connectors with or without additional structural support. In one embodiment, LED panels may permit high resolution including a large number of colored, closely spaced pixels permitting a clear, high resolution image, series of images, and/or video.

The video display system 100 is configured, such that, the video display subcomponent 103 abuts directly to the adjacent video display subcomponent 103, thus displaying an image as a substantially continuous display surface 109 capable of displaying a continuous image 111. By substantially continuous display surface 109 and continuous image 111, it is meant that the surface and image have the appearance of being continuous when being observed by a viewer with few or no gaps being visible between the video display subcomponents 103. Minor gaps, seams or other discontinuities between the video display subcomponents 103 may be present, provided the visual appearance by an observer is continuous. The continuous image 111 may be any suitable display, including video, images or lighting effects. As utilized herein, “video” includes moving or still images displayed on an electronic media interface, such as the plurality of video display subcomponents 103, and may be provided in any known format for providing moving or still images.

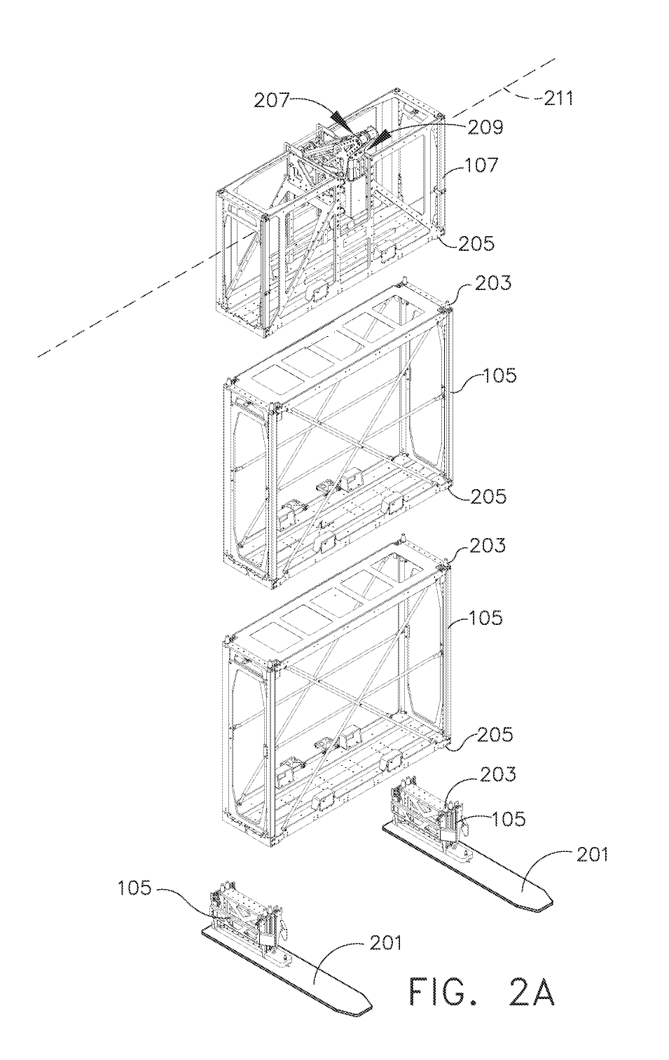

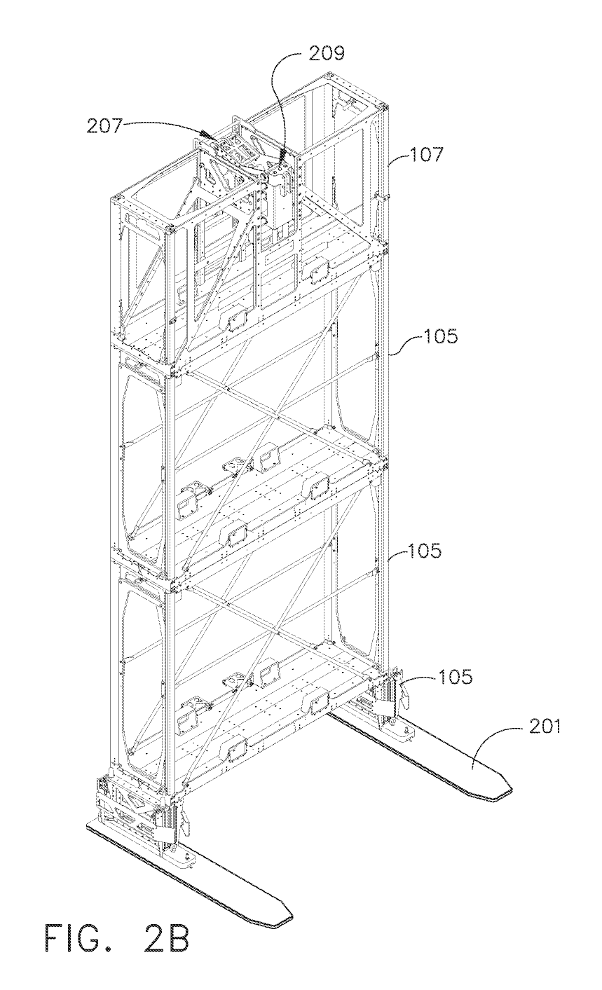

FIG. 2A shows an exploded view of the video support structure 101, including the base support assemblies 105 and the lift support assembly 107. FIG. 2B shows the video support structure 101 of FIG. 2A in an assembled configuration. As illustrated in FIGS. 2A and 2B, the base support assemblies 105 include a footer structure 201 that provides stability and rests upon the ground or desired surface to receive the video display system 100. As is visible in FIG. 2A, the base support assembly 105 includes tapered connectors 203 that are received by receiving member 205 in the lift support assembly 107 and the base support assemblies 105 to provide a multi-level structure. The number of levels are not limited to the number of levels shown in FIGS. 2A and 2B, but may include any number of levels desired to provide the height and portability of the desired video display system 100. The tapered connectors 203 include a frusto-conical geometry having a tapered surface that frictionally engages a corresponding tapered surface in the receiving member 205 in the adjacent base support assembly 105 or the lift support assembly 107. The engaged tapered surfaces provide assistance in alignment and provide stability for the assembled video support structure 101. As shown in FIG. 2A, the tapered connectors 203 and the receiving members 205 are positioned at the four corners of the structure, but any number of tapered connectors 203 at any suitable position may be used. The video support structure 101 is not limited to the use of tapered connectors 203 and receiving members 205 and may use any suitable connection system known in the art for providing stacked structural components. The base support assemblies 105 and lift support assembly 107 may include additional features, such as ladders, hatches, walkways, conduit, cable runs, or any other features useful for providing functionality and increased serviceability to the video display system 100.

To assemble the video support structure 101, a base support assembly 105, including footer structure 201, is positioned on a surface, such as the floor, of a venue. Additional base support assemblies 105 are provided and directed onto the base support assembly 105 having the footer structure 201. Engagement between tapered connectors 203 and receiving members 205 provides support and alignment of the base support assemblies 105. Additional base support assemblies 105 are directed onto the positioned base support assemblies and a multi-level structure is formed. Once a desired height is achieved, a lift support assembly 107 is directed onto the base support assembly 105. The assembled video support structure is shown in FIG. 2B.

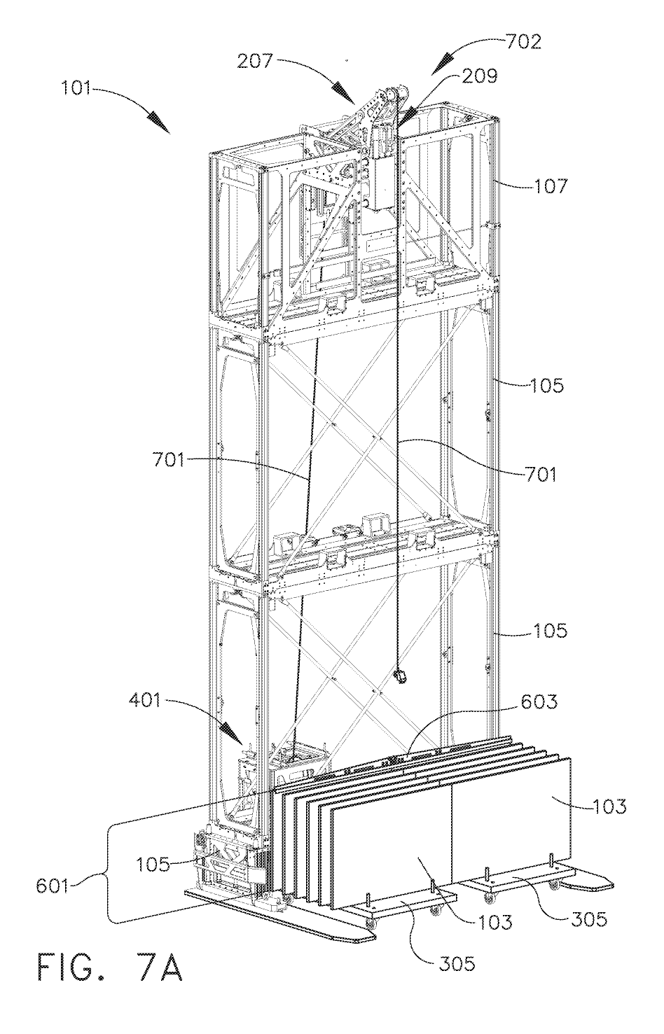

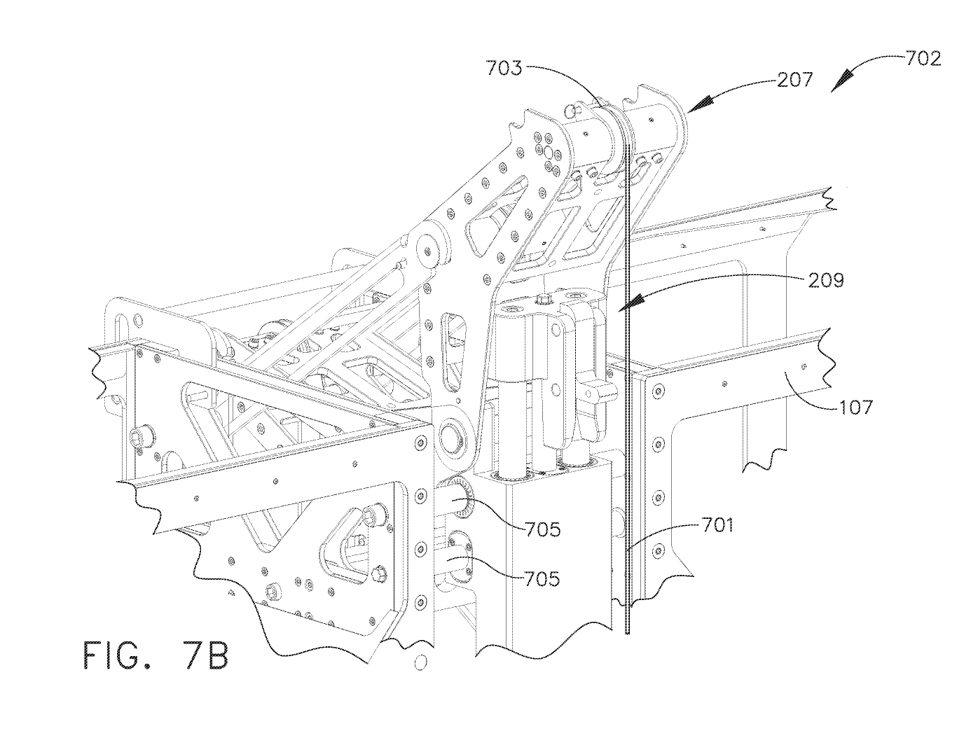

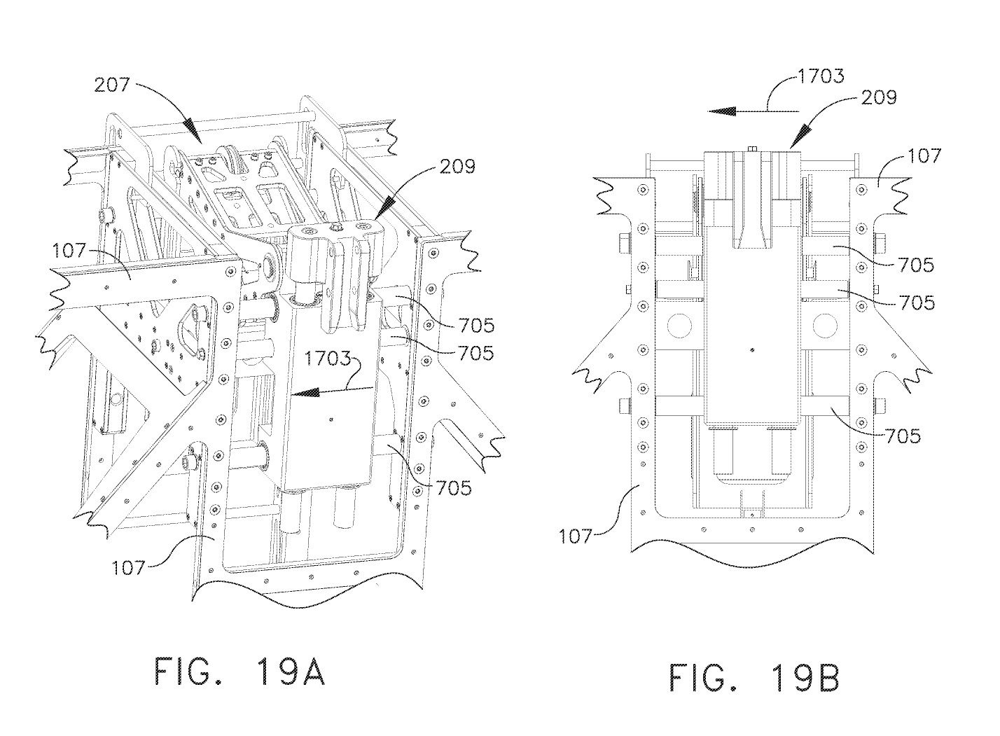

As shown in FIGS. 2A and 2B, the lift support assembly 107 includes a lifting device 207 and a retention device 209. The lifting device 207 includes a series of sheaves, pulleys or other structures for receiving and guiding a cable, rope, wire, chain or other flexible member suitable for lifting (see expanded view in FIG. 7B). The lifting device 207 is retractable between a first deployed position (see FIG. 2A) and a second retracted position (see FIG. 2B). In addition, the lifting device 207 is movable in a lateral direction along axis 211. The lateral movement of lifting device 207 may be provided by any suitable method, including sliding or rolling of the lifting device 207 along a cylinder or bearing structure (see also FIGS. 19A and 19B). The retention device 209 includes clips, fasteners, features or other components for engaging and supporting a plurality of video display subcomponents 103. Like the lifting device 207, the retention device 209 is movable along axis 211 and is movable by any suitable method, including sliding or rolling of the retention device 209 along a cylinder or bearing structure. While FIGS. 2A and 2B show a video support, a lift support assembly 107 wherein both the lifting device 207 and the retention device 209 are movable in a lateral direction of axis 211, alternatively, one of the lifting device 207 or the retention device 209 may be fixed in the direction of axis 211.

The various components of the video support structure 101 are constructed of any suitable durable material. For example, the components may be fabricated from metal, such as steel, galvanized steel, stainless steel, aluminum, their alloys or combinations therefore. In one embodiment, a lightweight material, such as aluminum or low gauge steel, is provided to provide a lighter weight component for handling, transportation and storage. In another embodiment, support component surfaces are plated, painted, anodized, power coated or otherwise treated to resist corrosion, afford protection against the rigors of construction, storage and transportation, and to provide aesthetic appeal, for example, a flat or low gloss coating to conceal the video support structure 101 during the concert, performance, or stage production.

As shown in FIG. 2B, the assembled video support structure 101 may include the base support assemblies 105 and lift support assemblies latched or detachably engaged with one another. The latching or detachable engagement may be provided by any suitable method, including hand actuated latches. Suitable latches include an adjustable latch or draw latch fastening device having a U-shaped yoke or hook, with a bracket and yoke interconnected to a handle that pivots from a hinge on a mounting bracket. Alternatively, coffin locks or similar flat surface connectors may be utilized to attach the base support assemblies 105 and the lift support assemblies 107 together. The latches are not limited to the above and may include any suitable fasteners for assembling/disassembling support structures. Preferably the latches allow engagement and disengagement without the assistance of tools.

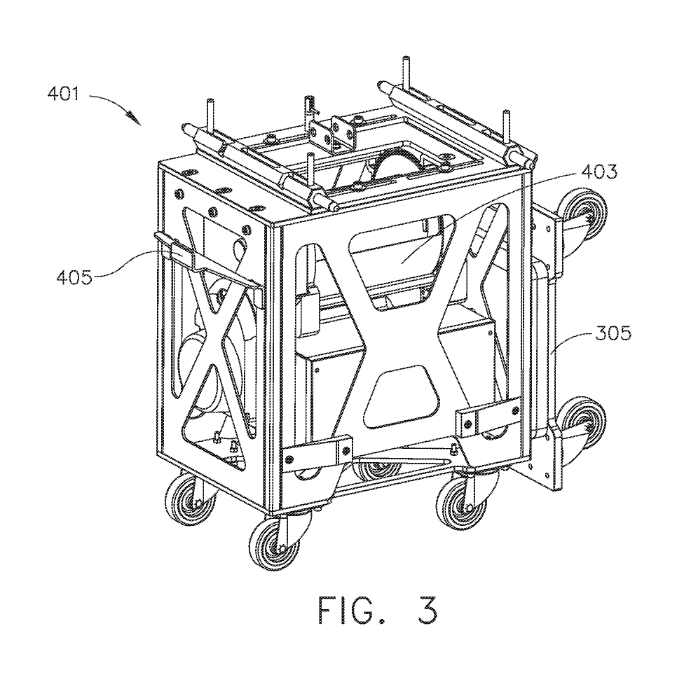

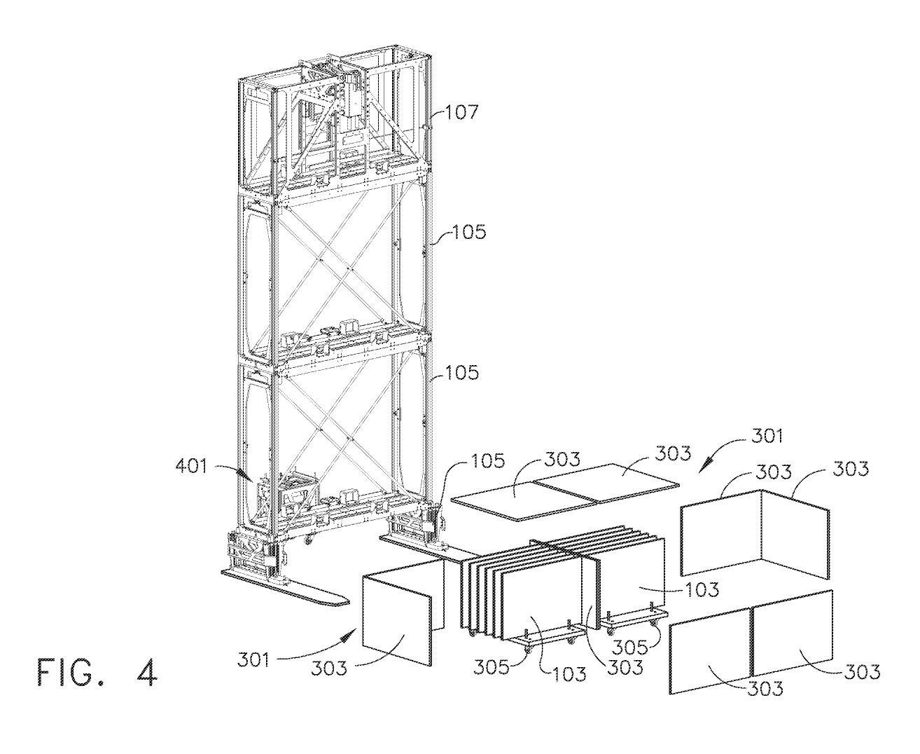

As shown in FIG. 3, a winch dolly 401 is provided to provide lifting. The winch dolly includes a motorized winch 403 or similar device configured to retract or deploy a flexible lift member 701, such as a cable, rope, wire, or chain about a wheel or drum (see for example, FIGS. 7A and 7B). The flexible lift member 701 is directed over the lifting device 207 to lift the video display subcomponents 103. In one embodiment, as shown in FIG. 4, the winch dolly 401 includes a storage hook 405 to support equipment, such as caster assembly 305 from transportation carts 301 (see example FIG. 4).

FIGS. 4-14B illustrate the process of assembling the video display system 100 using a video support structure 101.

FIG. 4 also shows positioning of video display subcomponents 103 for assembly into the video display system 100 (see for example, FIG. 1). The video display subcomponents 103 are provided on transportation carts 301 shown with protective panels 303 partially removed. During transportation and/or storage protective panels 303 are secured around video display subcomponents 103 using any suitable latching or securing technique. The transportation carts 301 include caster assemblies 305 or other movement facilitating structures to permit positioning of the video display subcomponents 103. The protective panels 303 protect the video display subcomponents 103 during transportation and storage and are removed prior to assembly of the video display system. The protective panels 303 are latched or fastened together and are preferably disengaged and removable without the assistance of tools. The plurality of video display subcomponents 103 are exposed in preparation for lifting and engaging.

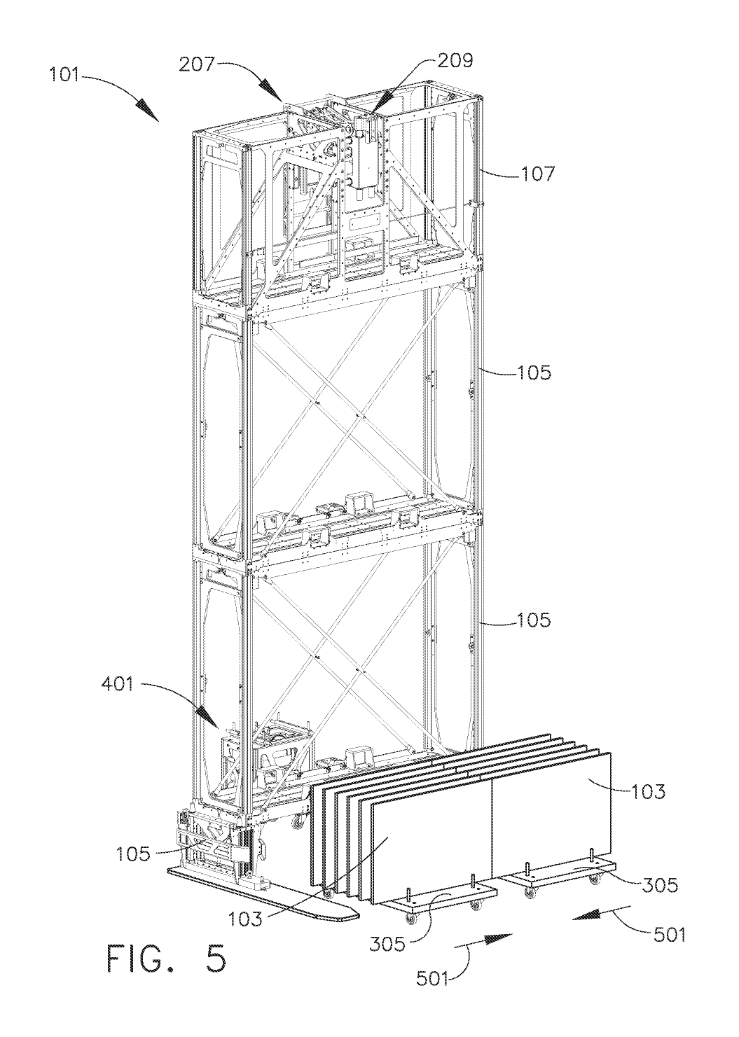

Referring to FIG. 5, video display subcomponents 103 on caster assemblies 305 are conveyed and positioned in close proximity to the video support structure 101. The video display subcomponents 103 are directed toward each other in direction 501 and latched together using latches or other suitable fasteners known in the art for detachably engaging mechanical components. Preferably, the latches do not require the assistance of tools to attach or detach the components from one another. Suitable latches may include draw latches.

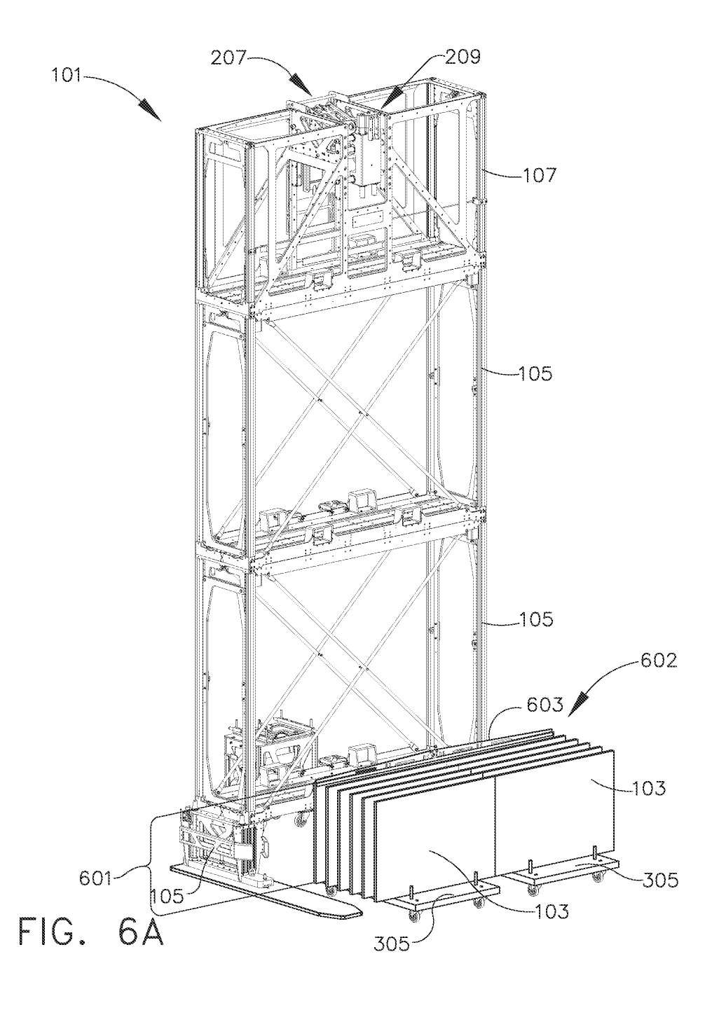

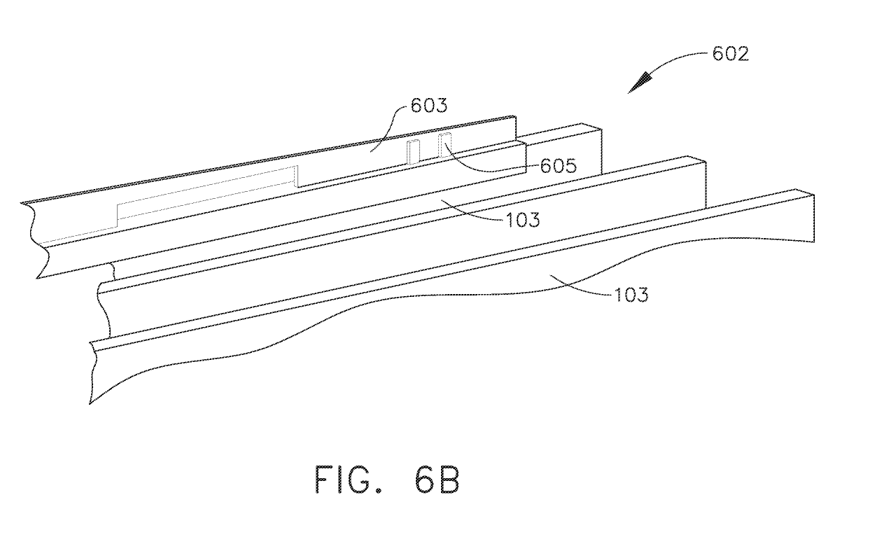

As shown in FIG. 6A, a first display tier 601 made up of engaged video display subcomponents 103 are detachably engaged to a hang bracket 603. FIG. 6B shows an expanded view of area 602 of FIG. 6A. The detachable engagement between the hang bracket 603 and the video display subcomponents 103 can be accomplished with clips 605 or other suitable fastening devices.

As shown in FIG. 7A, a winch dolly 401 is positioned in close proximity to the video support structure 101 and a flexible lift member 701 is directed over the lifting device 207. FIG. 7B shows an expanded view of area 702 of FIG. 7A. As is visible in FIG. 7B, lifting device 207 includes at least one sheave 703 or pulley to support and guide the flexible lift member 701. Any arrangement of sheaves 703 on the lifting device 207 that provides support and guidance of the flexible lift member 701 may be utilized. Also, as visible in FIG. 7B, the lifting device 207 and retention device 209 are mounted on positioning cylinders 705 that support the lifting device 207 and retention device 209 and also permit lateral motion of the lifting device 207 and retention device with respect to the lift support assembly 107. The movement is permitted by rolling of other suitable bearing arrangements that allow lateral movement of the lifting device 207 and the retention device 209, while the lift support assembly 107 remains fixed (see also FIG. 2A).

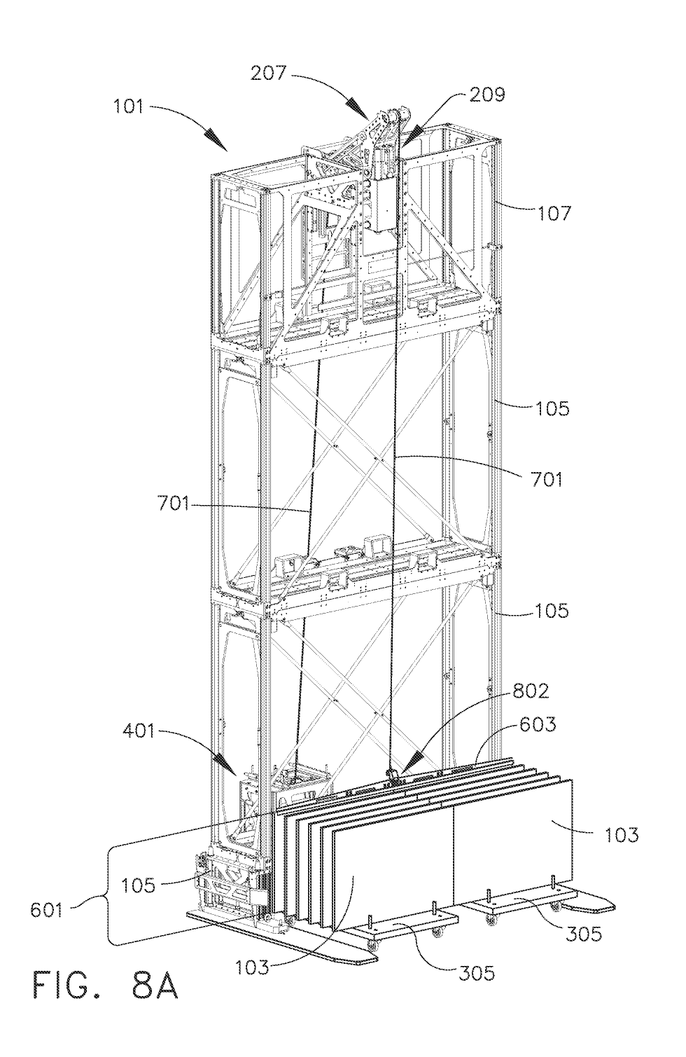

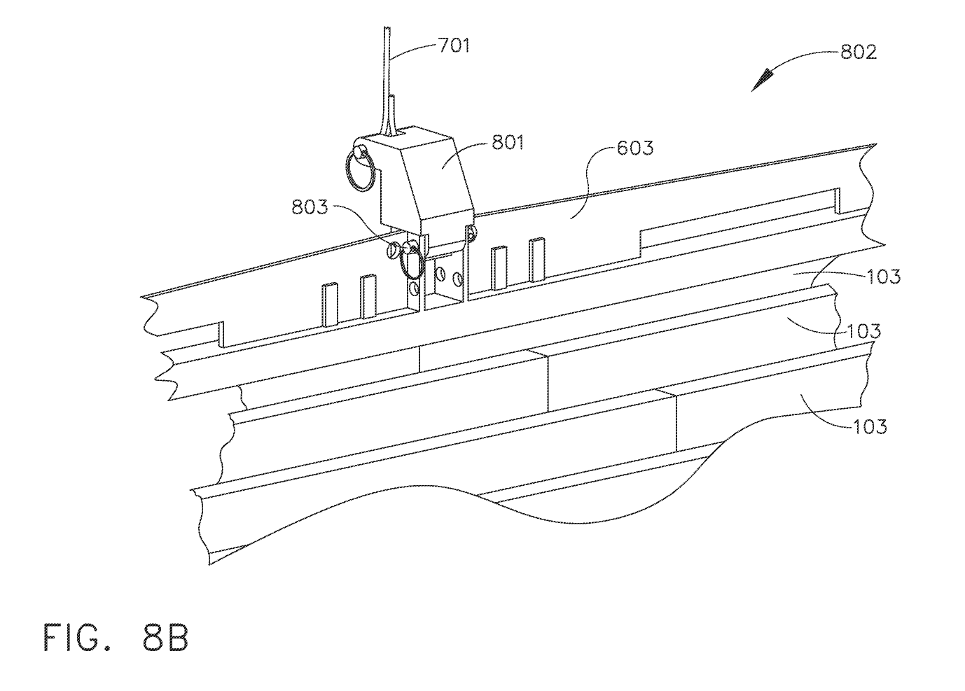

As shown in FIG. 8A, the flexible lift member 701 is attached to the hang bracket 603 to facilitate lifting with the winch dolly 401. FIG. 8B shows an expanded view of area 802 of FIG. 8A. As is visible in FIG. 8B, a lift bracket 801 attached to the flexible lift member 701 is detachably engaged to the hang bracket 603. The lift bracket 801 and hang bracket 603 are detachably engaged using suitable fasteners. In one embodiment, the lift bracket 801 and the hang bracket 603 are engaged using one or more lift locking pins 803 (as shown in FIG. 8B), latches or similar fasteners that can be disengaged without the assistance of tools. Suitable locking pins include, for example, but are not limited to, adjustable expanding pins, positive locking quick-release pins, double-ball self-locking pins, clevis pins having one or more holes to receive a cotter pin or hairpin, clevis pins having a machined grove to receive a snap ring, swivel-clip locking clevis pins, hitch pins, linch pins, or lock pins.

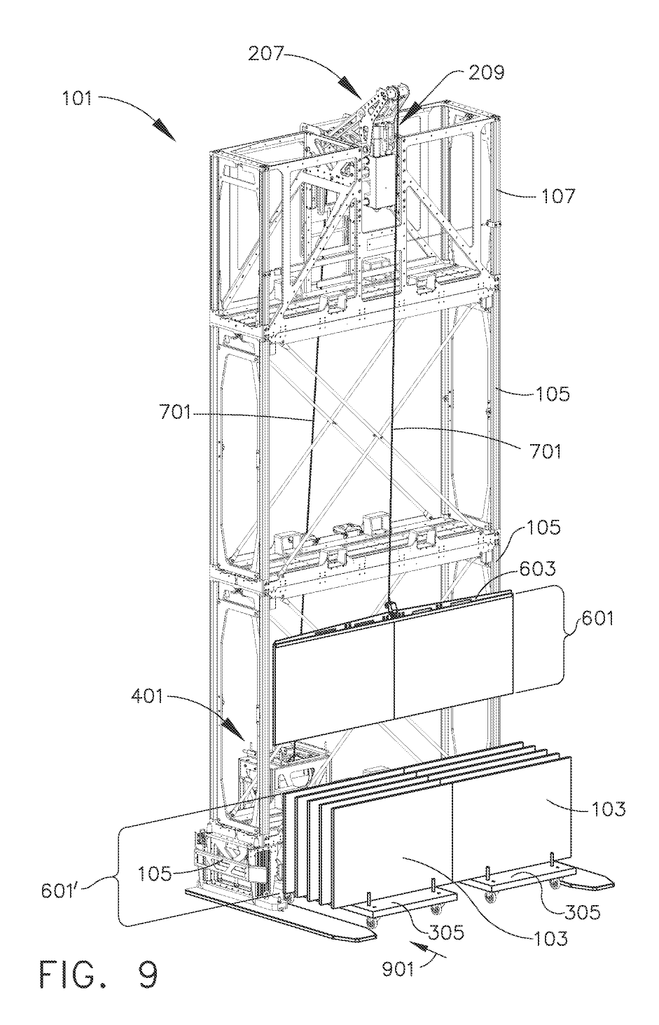

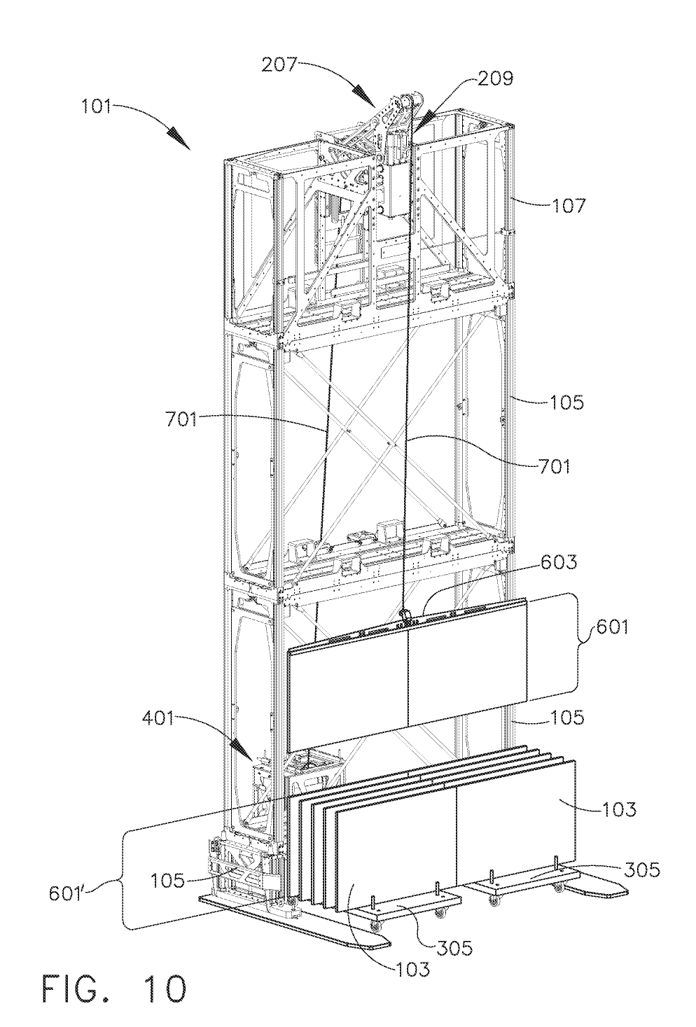

As shown in FIG. 9, the first display tier 601 is lifted using the winch dolly 401 and flexible lift member 701. The first display tier 601 is lifted above a second display tier 601′ and the caster assemblies 305 are directed toward the video support structure 101 in direction 901 such that the first display tier 601 aligns vertically with second display tier 601′ (as shown in FIG. 10).

FIG. 10 shows the caster assemblies 305 with video display subcomponents 103 in first display tier 601 in vertical alignment with video display subcomponents 103 in second display tier 601′. The alignment of the first display tier 601 and the second display tier 601′ is such that the first display tier 601 can be lowered directly onto the second display tier 601′.

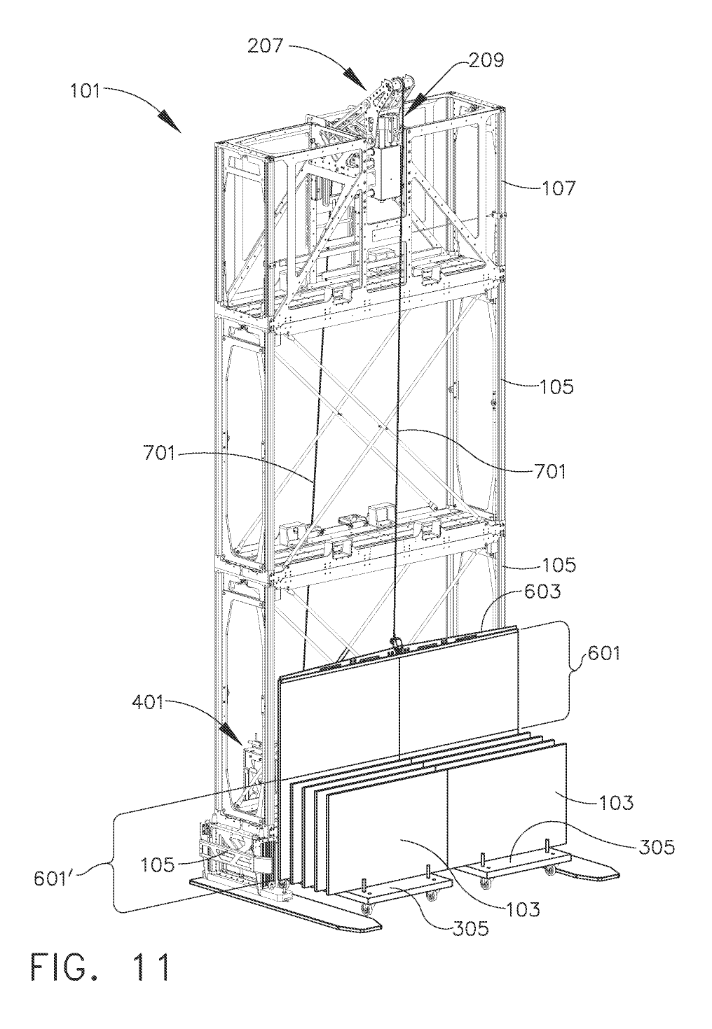

As shown in FIG. 11, the first display tier 601 is lowered onto second display tier 601′ and the first display tier 601 and the second display tier 601′ are latched together using latches or other suitable fasteners known in the art for detachably engaging mechanical components. Preferably, the latches do not require the assistance of tools to attach or detach the components from one another. Suitable latches may include draw latches. In another embodiment, the video display subcomponents 103 automatically latch together when the first display tier 601 contacts the second display tier 601′ wherein the weight of the first display tier 601 actuates the latches.

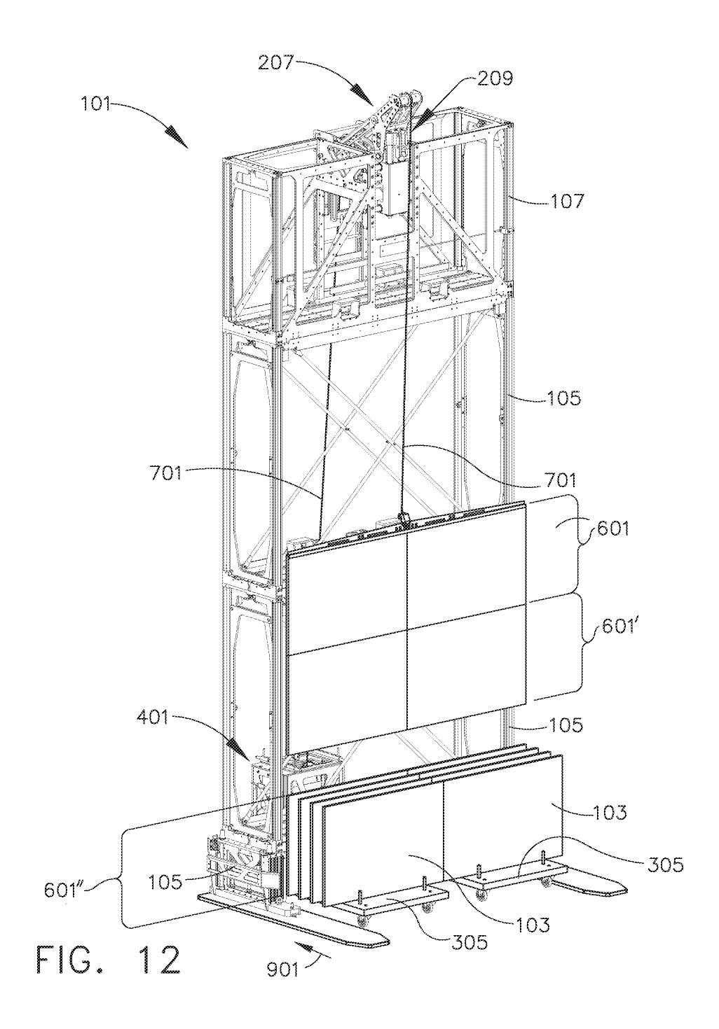

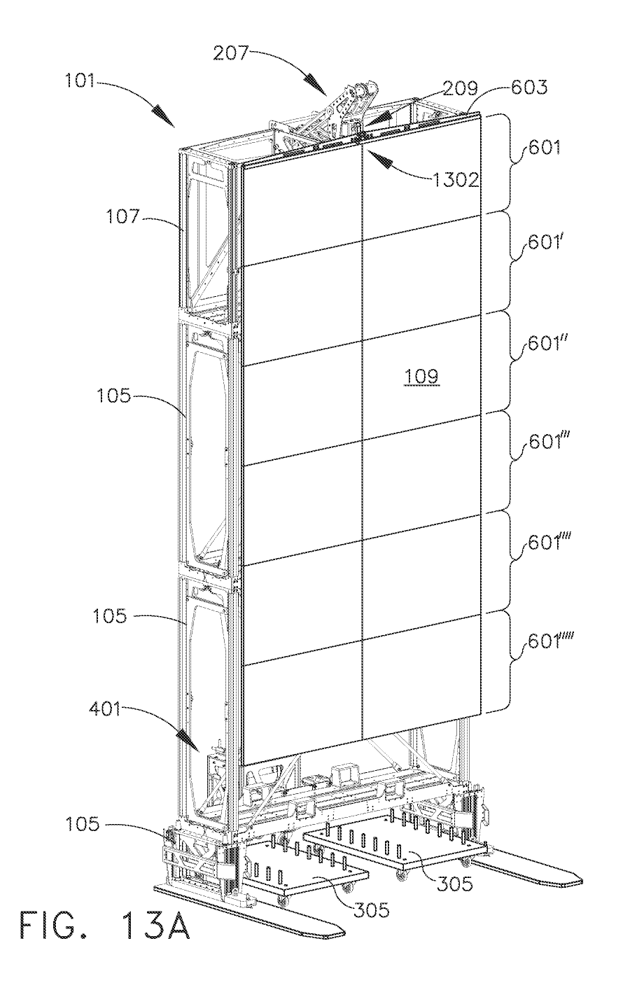

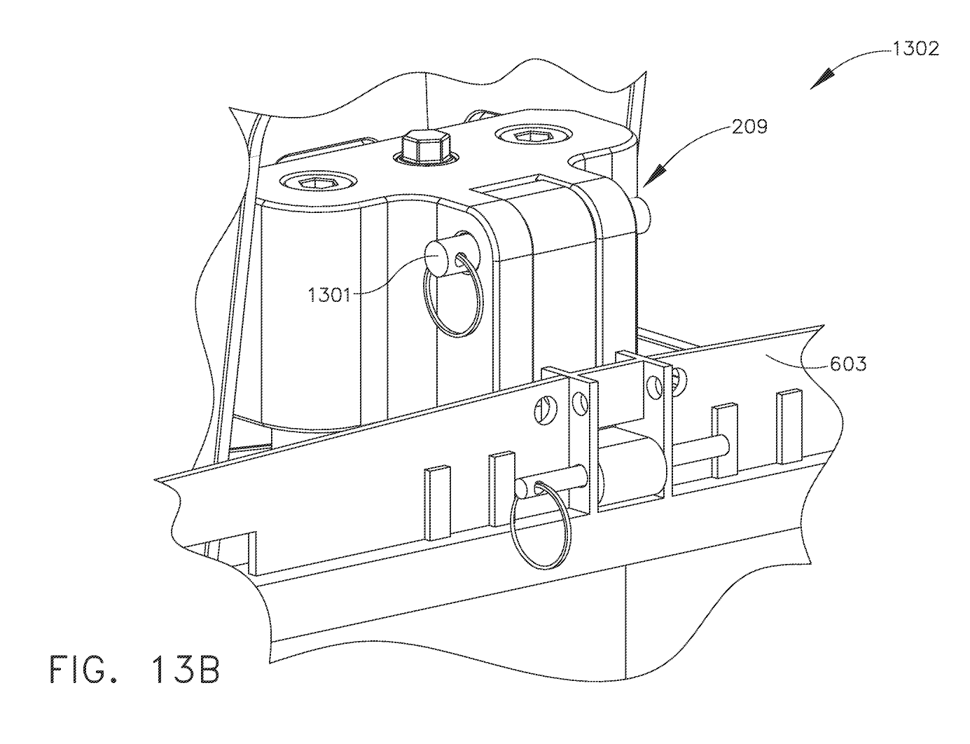

As shown in FIG. 12, the first tier 601 and the second tier 601′ are lifted together with the winch dolly 401 and the flexible lift member 701. Similar to the step shown in FIGS. 9 and 10, a third display tier 601″ is positioned in alignment with the second display tier 601′ and the process is repeated until a desired height is achieved (see FIG. 13A).

As is shown in FIG. 13A, the lift bracket 801 is disengaged from the hang bracket 603 and the hang bracket 603 is engaged to the retention device 209. FIG. 13B shows an expanded view of area 1302 of FIG. 13A. As is best visible in FIG. 13B, the hang bracket is engaged with retention device with a retention locking pin 1301. Latches or similar fasteners may also be used that, in one embodiment, can be disengaged without the assistance of tools.

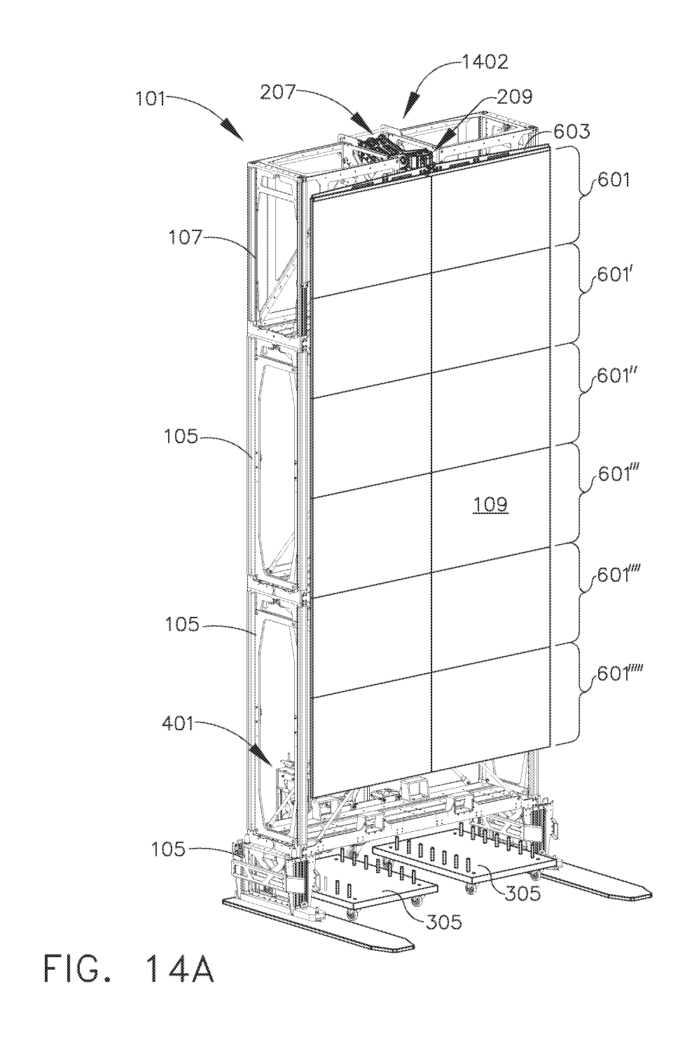

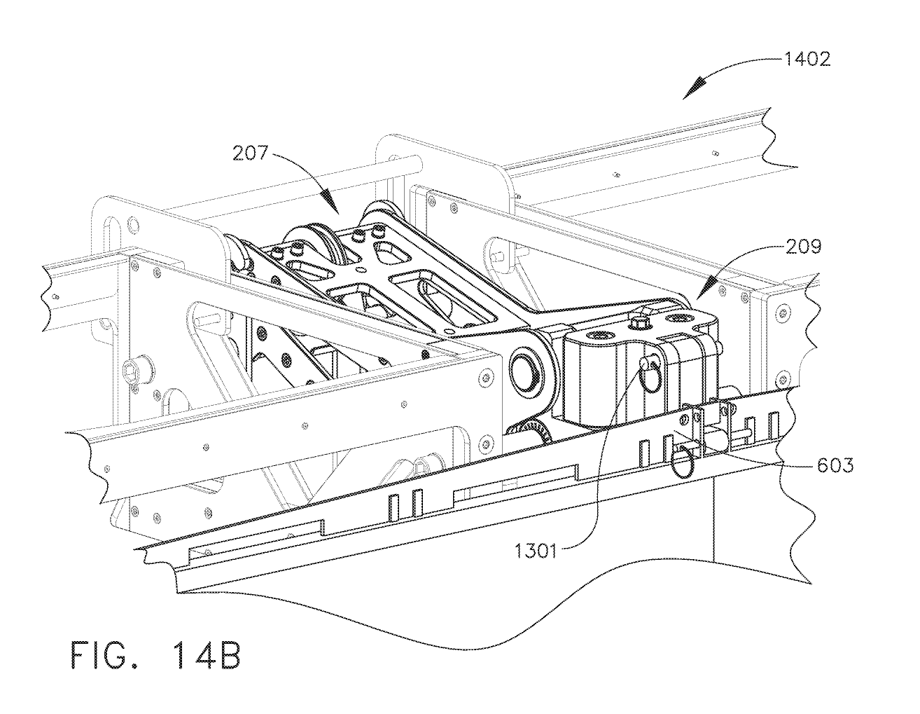

The built-up continuous display surface 109 made up of display tiers 601, 601′, 601″, 601′″, 601″″, and 601 is not limited to the number of tiers or the specific configuration of video display subcomponents 103 shown in FIG. 13A. Any number of display tiers 601 and any suitable configuration of video display subcomponents 103 may be utilized. FIG. 14A includes an additional method step wherein the lifting device 207 is retracted to a position within the lift support assembly to minimize its visibility during operation of the video display system 100 (see for example, FIG. 1). FIG. 14B shows an expanded view of area 1402 of FIG. 14A. FIG. 14B shows detail of the lifting device 207 in the retracted position. In addition, to continue expanding laterally the size of the video display system 100, additional video support structures 101 may be positioned next to each other and the process of FIGS. 4-14B is repeated until the desired lateral size of the system is provided.

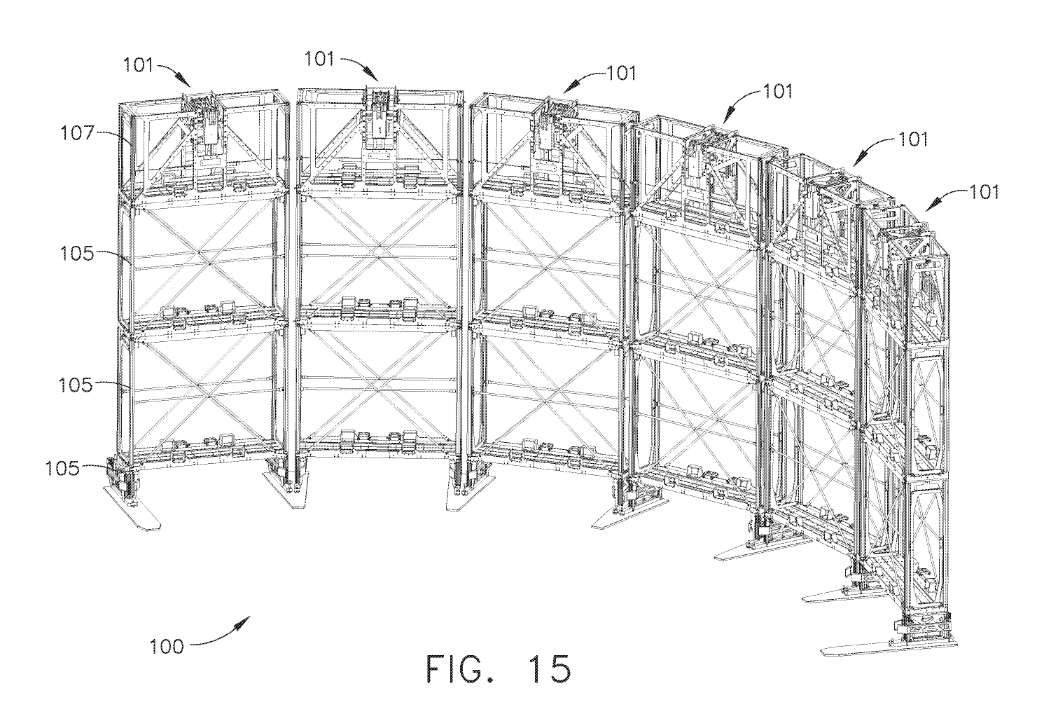

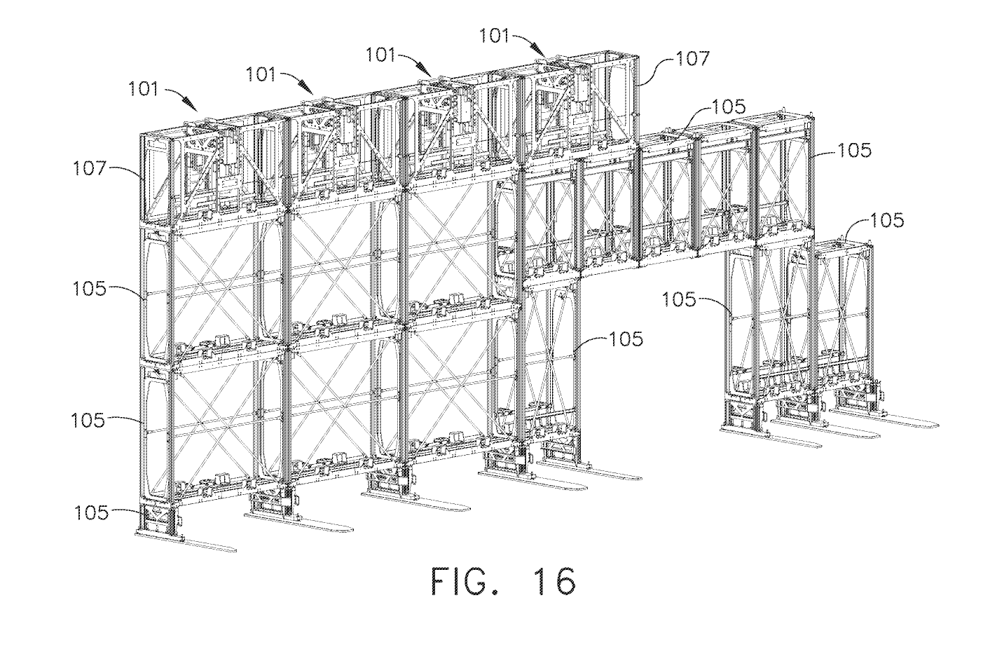

An alternate embodiment of the video display system 100 is shown in FIG. 15 with the video display subcomponents 103 removed, wherein the video support structures 101 are assembled in an arc-like geometry to form a curved continuous display surface. Still another alternate embodiment of the video display system 100 is shown in FIG. 16, wherein a discontinuous structure is shown to allow bridging over doorways or other features.

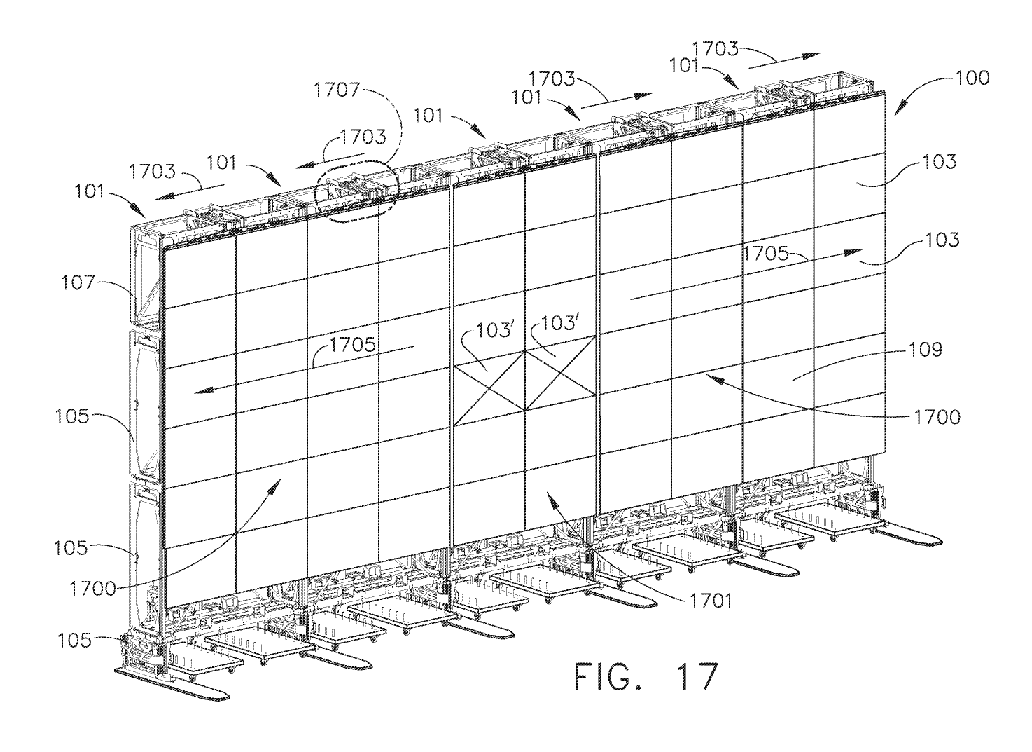

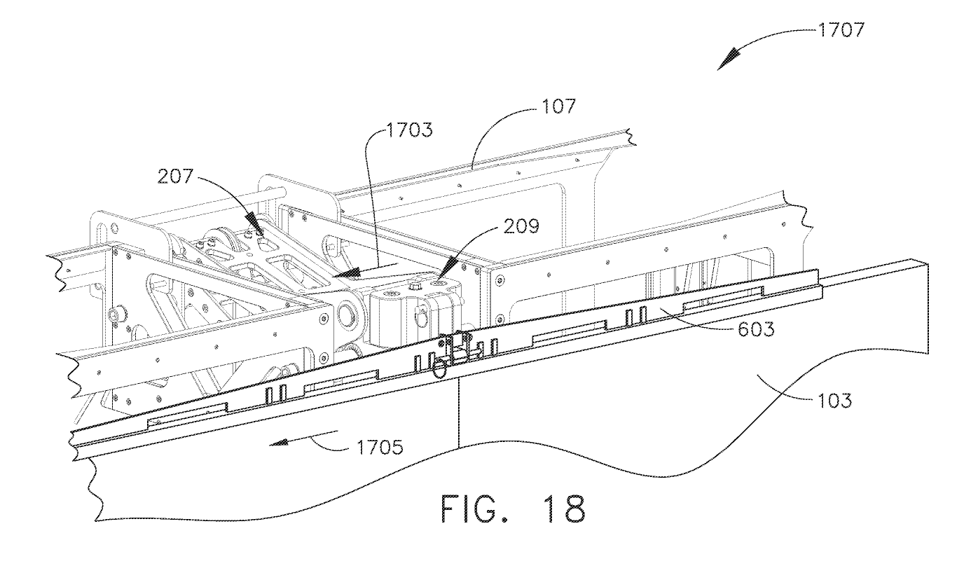

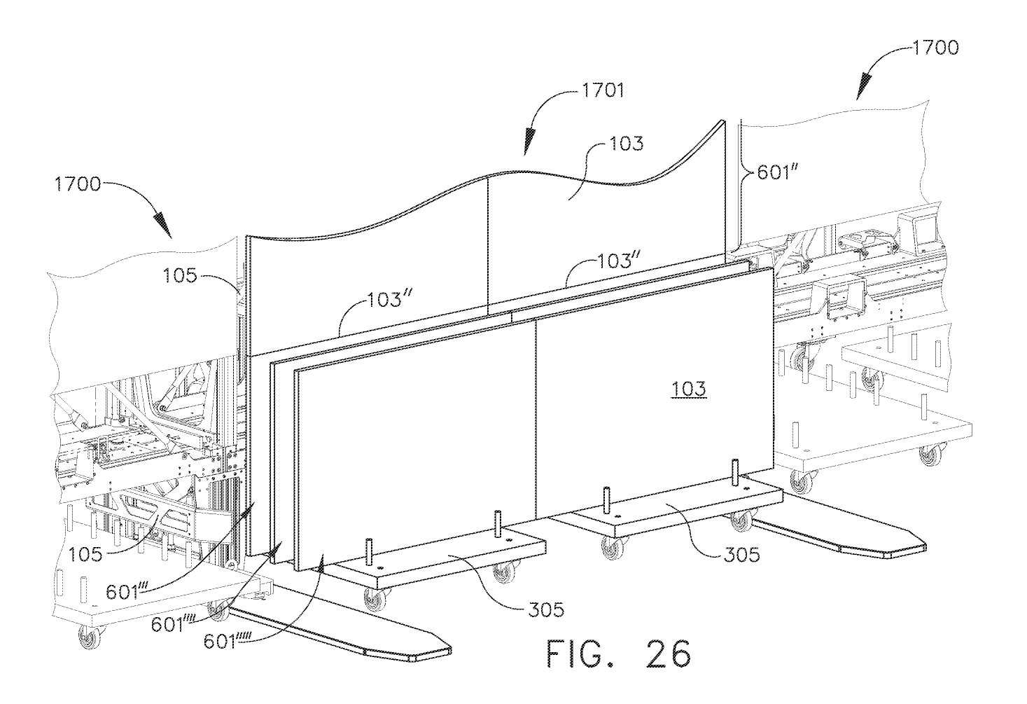

As shown in FIGS. 17-27, the video display system 100 of the present disclosure permits serviceability without disassembly of the entire or significant portions of the video display system 100. To provide a repair or replacement of individual or groups of video display subcomponents 103, section 1700 and repair section 1701 are detached from each other, by disengaging the latches or other fasteners holding the video display subcomponents 103 together in the lateral direction. As shown in FIG. 17, the display surface 109 is separated by moving sections 1700 of video display subcomponents 103 in directions 1705 to isolate a repair section 1701 including one or more video display subcomponents 103′ requiring replacement or repair. To provide the isolation, the retention devices 209 in section 1700 are moved in direction 1703 to permit movement of the video display subcomponents 103 with respect to the video support structure 101. This movement is shown in greater detail in the expanded view 1707, shown in FIG. 18, wherein the movement in direction 1703 is of the retention device, the hang bracket 603 and the video display subcomponents 103 with respect to a fixed lift support assembly 107.

FIGS. 19A and 19B show the retention device 209 and the lifting device 207 with the hang bracket 603 and the video display subcomponents 103 removed. As described above with respect to FIG. 7, the retention device 209 and lifting device 207 are mounted on positioning cylinders 705 that are fixedly mounted in the lift support assembly 107 that permit lateral motion within the lift support assembly 107. The motion is permitted by use of bearings or other similar structures that reduce friction and allow relative motion between retention device 209/lifting device 207 and the positioning cylinders. When a plurality of video support structures are assembled together, the movement along the positioning cylinders 705 allows the screen to be separated at any desirable location along the display surface 109. As described above in FIG. 17, the display surface can be separated into section 1700 and repair section 1701 by moving of each of the retention members in their respective lift support assemblies 107.

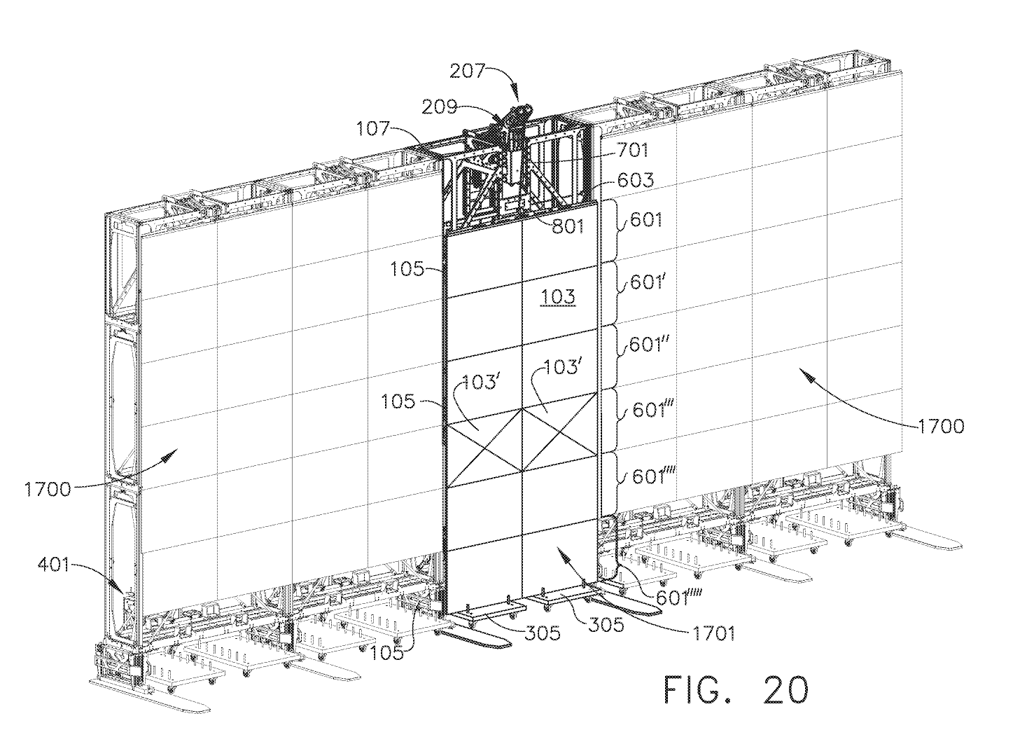

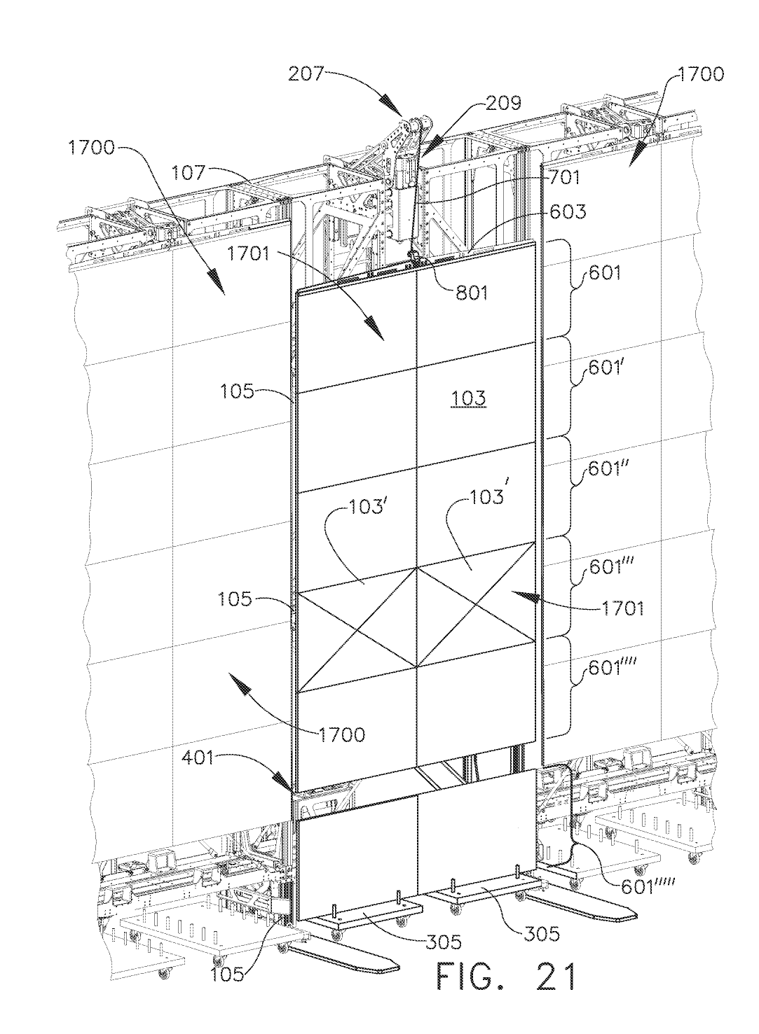

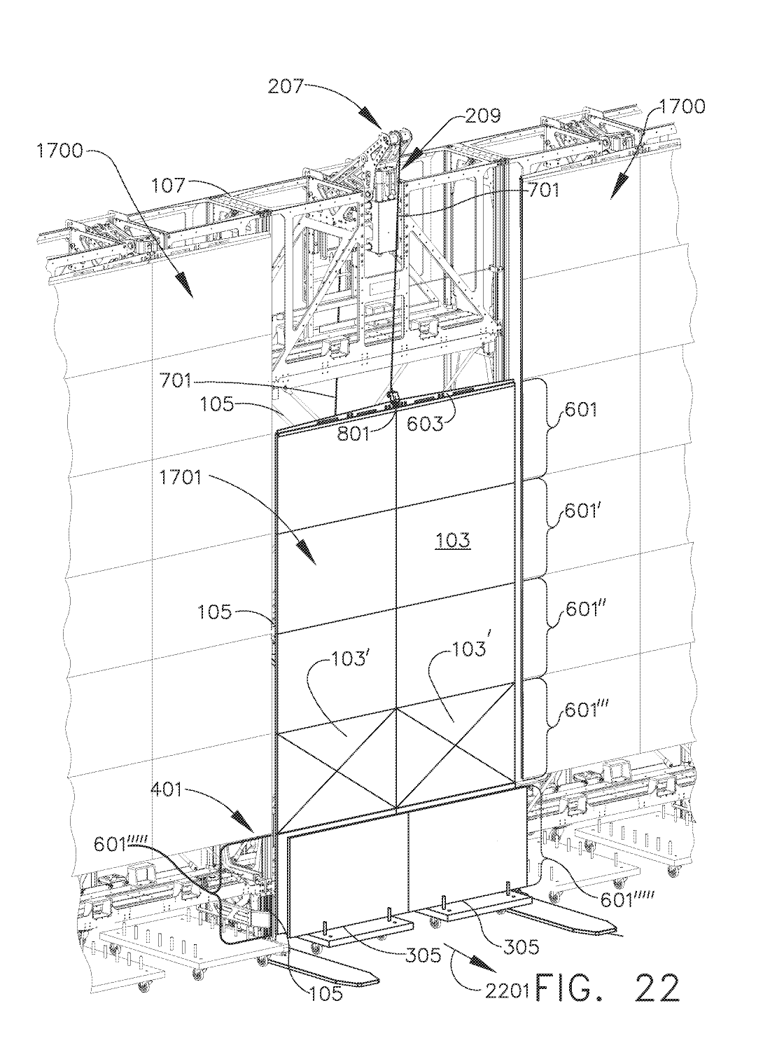

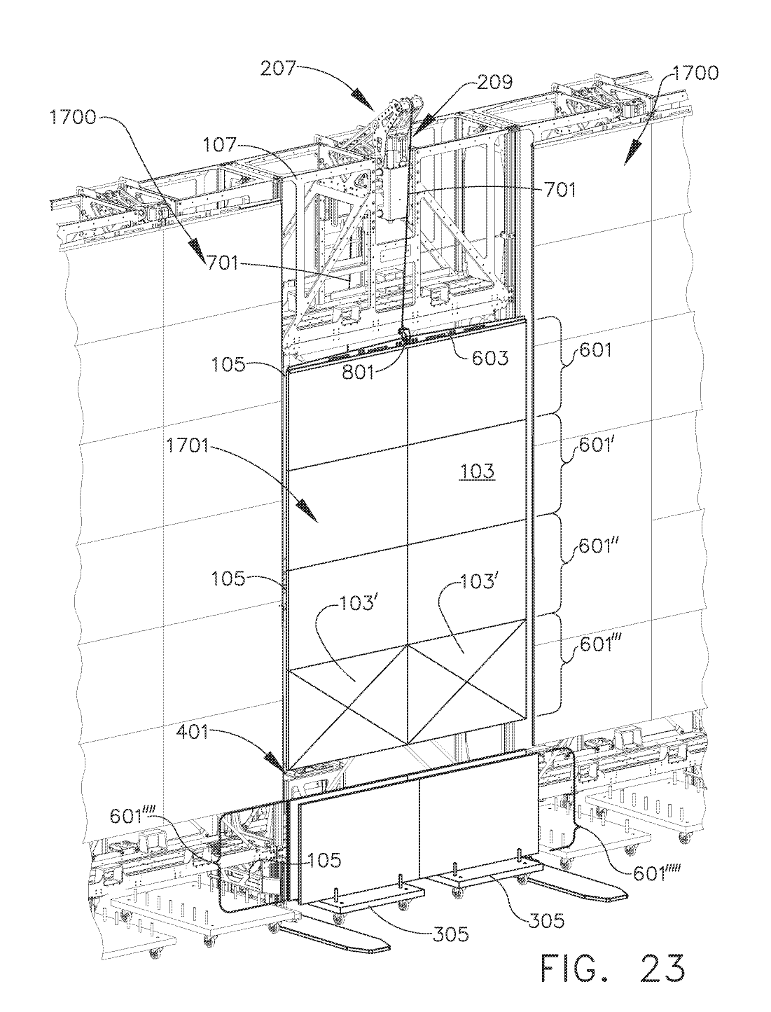

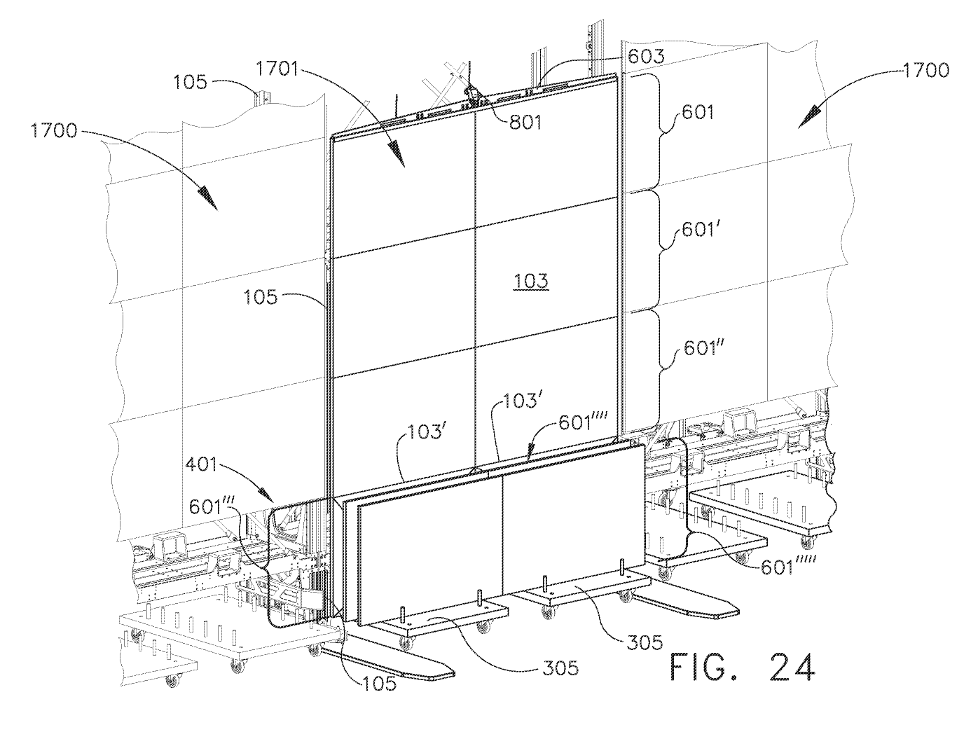

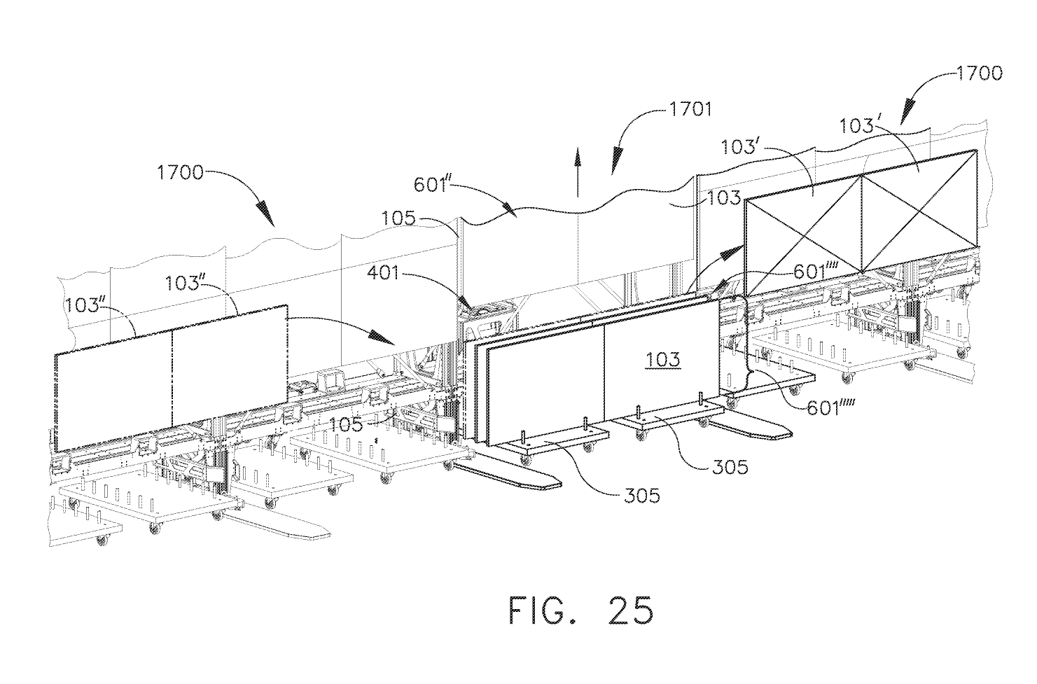

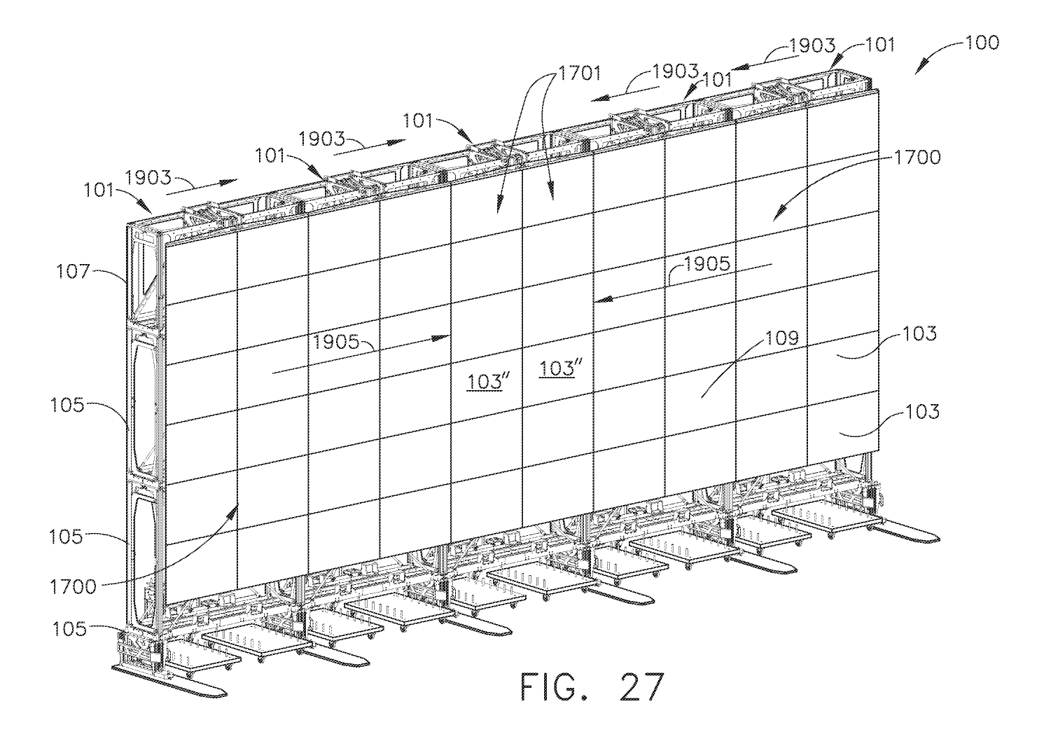

As shown in FIG. 20, in one embodiment, the lifting device 207 may be deployed to assist in the disassembly of the repair section 1700. As shown, the repair section 1700 is lowered to caster assemblies 305 and the display tiers 601 are separated from one another. As shown in FIG. 21, the remaining display tiers 601 are lifted from the tier stowed on caster assembly 305. As shown in FIG. 22, the caster assembly 305 is moved in direction 2201 to align the caster assembly 305 with the next display tier 601 and the process is repeated (see FIGS. 23-24) until video display subcomponents 103′ requiring replacement or repair are disengaged from the isolated section 1701 (see FIGS. 24-25). As shown in FIG. 25, the video display subcomponents 103′ requiring replacement or repair can be removed and replacement video display subcomponents 103” may be positioned as a replacement. Alternatively, the video display subcomponents 103′ requiring replacement or repair may be removed and serviced and returned to service once servicing is complete. Once the replacement video display subcomponents 103″ are in position, the process of FIGS. 17-24 are reversed. The video display subcomponents 103″ are latched or fastened to the adjacent video display subcomponents 103. Thereafter, as shown in FIG. 27, the sections 1700 are moved in direction 1905, with the retention device 209 moving in direction 1903 to form continuous display surface 109. The video display subcomponents 103 are all latched or fastened together and the display system 100 is in a suitable condition to return to service.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A portable video support structure comprising:
at least one base support assembly; and
at least one lift support assembly having:
a lifting device configured to lift a plurality of video display subcomponents; and
a retention device configured to receive and support the plurality of video display subcomponents;
wherein one or both of the lifting device and the retention device is capable of movement to position the plurality of video display subcomponents.

2. The portable video support structure of claim 1, wherein the plurality of video display subcomponents include low resolution video panels, high resolution video panels or combinations thereof.

3. The portable video support structure of claim 1, wherein the lifting device includes a flexible lift member and a winch.

4. The portable video support structure of claim 1, wherein the at least one base support assembly includes tapered connectors.

5. The portable video support structure of claim 1, wherein the lifting device is configurable into a retracted position and a deployed position.

6. A method of assembling a video display system comprising:
providing a video support structure having at least one base support assembly and at least one lift support assembly, the lift support assembly having a lifting device; and a retention device;
providing a video display subcomponent;
lifting the video display subcomponent with the lifting device;
providing an additional video display subcomponent;
detachably engaging the additional video display subcomponent with the video display subcomponent;
lifting the video display subcomponent and the additional video display subcomponent with the lifting device;
providing, lifting and detachably engaging additional video display subcomponents until a predetermined number of video display subcomponents are engaged with one another; and
detachably engaging one of the video display subcomponents or the additional video display subcomponents to the retention member to form a substantially continuous display surface.

7. The method of claim 6, wherein the plurality of video display subcomponents include low resolution video panels, a high resolution video panel or combinations thereof.

8. The method of claim 6, further comprising providing an additional video support structure.

9. The method of claim 6, further comprising detaching a section of video display subcomponents.

10. The method of claim 9, further comprising moving the retention device to separate the section of video display components.

11. The method of claim 10, further comprising removing and replacing at least one video display subcomponent.

12. The method of claim 10, further comprising moving the lifting device to separate the section of video display components.

13. The method of claim 12, further comprising removing and replacing at least one video display subcomponent.

14. The method of claim 6, further comprising directing the lifting device into a retracted position after detachably engaging the one of the video display subcomponents or the additional video display subcomponents to the retention member.

15. A video display system comprising:
a plurality of portable video support structures each comprising:
at least one base support assembly; and
at least one lift support assembly having:
a lifting device configured to lift a plurality of video display subcomponents; and
a retention device receiving and supporting the plurality of video display subcomponents;
wherein one or both of the lifting device and the retention device is capable of movement to position the plurality of video display subcomponents and the video display subcomponents being detachably engaged with one another to form a substantially continuous display surface.

16. The video display system of claim 15, wherein the plurality of video display subcomponents include low resolution video panels, a high resolution video panel or combinations thereof.

17. The video display system of claim 15, wherein the video display system includes greater than two video display subcomponents.

18. The video display system of claim 15, wherein the retention device is movable to separate the section of video display components.

19. The video display system of claim 15, wherein the lifting device is movable to separate the section of video display components.

20. The video display system of claim 15, wherein the lifting device is configurable into a retracted position and a deployed position.
